(19) United States
(12) Patent Application Publication
(10) Pub. No.: US 2006/0235904 A1
(43) Pub. Date: Oct. 19, 2006

(54) Method for preserving access to system in case of disaster

(76) Inventor: Rajesh Kapur, Toronto (CA)

Correspondence Address: Rajesh Kapur, 264 Huntsmill blvd, Toronto, ON, MIW 3G6, CA

(21) Appl. No.: 11/389,597

(22) Filed: Mar. 27, 2006

(30) Foreign Application Priority Data
Apr. 14, 2005 (CA) 2,504,070
May 4, 2005 (CA) 2506,100
May 4, 2005 (CA) 2506,303
Jul. 28, 2005 (GB) 0515579.1

(51) Int. Cl. G06F 17/30

(52) U.S. Cl. 707/202

(57) ABSTRACT

A method for preserving access to document data within a system in a separate location, wherein said document data is stored in a system filestore associated with a system database, the system database containing reference data to point to the document data within the system filestore, in case of disaster to the primary system such as, earthquake, the secondary system can be used, the method comprising steps of: creating a replicated server containing the system database and filestore; determining that a insert, update, delete command has been issued within the primary production system database upon its system tables excepting those containing reference information that uniquely identifies the production system database from its replica on the network fabric; transferring and recording the commands above to the database system tables of the replica based on time of earliest recorded data; transferring recorded document data to secondary filestore using incremental filestore backup transfers;

### FIELD OF INVENTION

The present invention relates to a method, system for allowing systems professionals to retrieve a document management system, quickly in a off site location in the case of disaster, Test upgrades etc in a document management system.

A partial real-time solution is encompassed.

### DESCRIPTION OF THE RELATED ART

a method developed and presented at the Documentum Conference in Lisbon May 2004, “Upgrading to Documentum 5i using the Clean Build Toggle Clone Approach” http://www.momentumeurope.com/conf_track3.shtml.

In this method a replicated server ( document data within a system in a separate location, wherein the document data is stored in a system filestore associated with a system database) was built, upgraded, plurality of data was achieved but only at a point in time in order to switch or toggle the new replica to become the production system. The data was copied from the filestore using a full backup/restore on the Thursday night to the secondary backup store, on Friday night the Primary production server was shutdown and incremental backup and database export taken and these applied to the secondary server. This step ensured the plurality of the data for the point in time when after testing a switch could be made. This method forms one of the foundation stones of this Invention, however, suffers from the fallback that the two systems are only in sync for a point in time.

The second foundation stone of this invention is File number is co-pending application number CA2,504,070, CTC002 submitted Apr. 14^{th} 2005 for Patent in Canada, in which the concept of access preservation tables to record the data is developed.

The third reference is that of fellow inventor Sandeep Jain Oracle Corporation U.S. Pat. No. 5,737,601.

Another foundation of this invention is that systems can be “Networked” i.e. joined together.

### SUMMARY OF THE INVENTION

Many large companies use document management software. The purpose of such software is to help companies keep track of large volumes of documents in an organized way, so that documents can be easily stored, found and retrieved. In many cases, there will be more than one version of a particular document. Thus, version control is another aspect of most document management systems. Version control is an issue of particular importance in situations where different people are able to share documents and have shared access to the documents, including a shared right to independently modify the documents.

One example of a company in which a document management software system would be useful is an engineering company that has many versions of the same part. When a client orders that part the company has to find the correct part version. The document management system typically includes a system database that is associated with a filestore. The filestore stores the actual document data, while the system database stores reference information that points to the document within the filestore. Also, the system database typically stores supplementary document information regarding each document.

Documentum™ is a document management system that comprises of three different layers(or technologies) sitting on top of an operating system (server based) such as Unix or Windows 2000 server, a system database, and a filestore.

The layers comprise of a Documentum application server layer that sits on top of the database and serves Documentum client interfaces. The reference information (i.e. the information pointing to the physical document data) and supplementary document information (i.e. the attributes of the types of Documents stored) are stored in the database. The actual physical data is stored in a filestore on either the server, a Storage area network (SAN) or Filer pointed to by the server.

As part of the management of a document management system the system database and filestore continue to grow in size. While this is a positive and desirable situation for the business as a whole, the company's data/Intellectual property is kept safe. This poses large problems systems people who need to maintain, upgrade these vast systems. The problem posed is also complicated by the range of different technologies involved. The document management system having its own layer to manipulate the user entry and the separate stores of data namely the system database and the filestore which need to be maintained consistently.

For example every company needs to maintain the availability of these large systems stretching for some large companies into the Terabytes of data. Should one of these systems fail over currently, the best method requires re-installing the database and document management software and recovering from backup tapes, and database exports. This at the very least would take days. This is unacceptable for most businesses.

Imagine the effect of a flood in the computer room or an earthquake it would mean total loss for perhaps days at the very least. This invention conquers the problem of synchronising the various components, thereby giving peace of mind to many Businesses.

With regards to major upgrades until very recently, most companies still preferred to completely write a new system and migrate data across, some still do this as the risk to their current system is so great.

This invention is described below. The combination steps allow the data to be synchronised at many points in time allowing the ease of recovery required immediately after a disaster.

What is required is a method for allowing systems professionals to retrieve a document management system, quickly in a off site location in the case of disaster.

Accordingly, there is provided a method for preserving access to document data within a system in a separate location, wherein said document data is stored in a system filestore associated with a system database, the system database containing reference data to point to the document data within the system filestore, In case of disaster to the primary system such as, earthquake, the secondary system can be used, the method comprising steps of:
creating a replicated server containing the system database and filestore;
determining that a insert, update, delete command has been issued within the primary production system database upon its system tables excepting those containing reference information that uniquely identifies the production system database from its replica on the network fabric;
transferring and recording the commands above to the database system tables of the replica based on time of earliest recorded data;
transferring recorded document data to secondary filestore using incremental backup transfers;

Preferably, the primary system is operably connected to a network fabric. Preferably, the secondary system is operably connected to the network fabric. Preferably, the primary system has information loaded onto it, and is based on the first server. Preferably, the secondary system has information loaded onto it, and is based on a second server. Preferably, the first system and the second system is configured to allow client computers operably connected to the network fabric to locate information owned by the first system and information owned by the second system.

Preferably, the second system replicates the first system. Preferably, the second system is located in an off-site location. Preferably, the system comprises a Document Management System residing on a server (Unix or Windows 2000 server) comprising of a filestore storing the actual document data and a system database storing reference information pointing to the documents within a filestore, supplementary information on the document, together with system specific information. Preferably, the second system's system database is configured to mirror the information in that of the first system's system database less a portion of the data which allows the second system to be uniquely identified on the network fabric.

Preferably, the filestore containing documents is connected to the network fabric. Preferably, the filestore is based on a Storage Area Network (SAN) or Filer connected to the network fabric. Preferably, the primary system's server can be connected to the filestore. Preferably, the secondary system's server can be connected to a separate filestore the second filestore in this case would need to have incremental backups from the first filestore to be continuously applied to it throughout perhaps at hourly intervals.

Preferably, the incremental backup is done every hour and automatically applied to the secondary filestore. Preferably, the primary and secondary system databases are linked through the network fabric. Preferably, the method comprises of using Oracle Database software linking primary and secondary system databases on the network fabric by means of an Oracle database link command.

Preferably, in the case of a SQL Server database this link between primary and secondary system databases is by a means of a SQL server linked server command. Preferably, both the primary and secondary systems databases have the required access permissions to access, modify, insert or delete data in each other and are accessible to each other across the network fabric. Preferably, the method comprises document data being added to the filestore and reference data modified within system tables in the primary system database, and wherein the recording step comprises the step of recording reference data from all primary system tables, save those holding system specific data.

Preferably, the primary system, in response to a insert, update, delete command, inserts, updates,deletes reference data to each of the system tables affected for each particular transaction. Preferably, the recording step comprises recording the reference data using at least one database trigger. Preferably, the recording step comprises recording the reference data using three database triggers associated with each system table, excepting those tables, which allow the first system to be uniquely identified on the network fabric. Preferably, the method comprises adding a first database trigger associated with recording the changes after an insert command on each table, adding a second database trigger associated with recording the changes after an update command on each table and adding a third database trigger associated with recording the changes after a delete command on each database table, excepting those tables that define the primary system on the network fabric.

Preferably, the method comprises performing identical changes, to that which can occur after an insert, update, delete command on each primary system database table and are recorded within the respective database trigger pertaining to that particular transaction to the identical replicated secondary system database table, by means of the salient SQL command contained within the three triggers on each of the primary database tables, the transfer, and application of the identical SQL command made possible only by the primary and secondary database systems being linked through a database link on the network fabric. Preferably, the three triggers on each table in the primary database also record the changes on update, insert, delete to access-preservation tables and a single transaction table for all changes on all tables.

Preferably, the single transaction table contains the group: the type of transaction ( i.e. update, delete, Insert), the system table on which the transaction is performed, the primary key of the table, and a Date-timestamp. Preferably, the recording step comprises using at least one access-preservation table. Preferably, the recording step comprises using a set of three access preservation tables for each primary system table to be mirrored in the secondary's database tables. Preferably, the method additionally comprises using a database stored procedure to apply the changes and transactions recorded in the access-preservation tables and transaction table, to the secondary system should the database link be severed for any reason including that of maintenance to the secondary system on a time based input parameter, once the database link is restored and user input is halted temporarily.

Preferably, a set of database procedures can be used in contingency the database link is severed for any reason to apply the changes and transactions recorded and in order, from the time the link was severed to the secondary system in order to synchronise the two systems once the database link is restored again, user input to be halted at this point until the procedures have finished running, then the system can be returned to the said automated transfer using the SQL command within the triggers on each table, with the user input recommenced. Preferably, the access-preservation tables and the combined transaction table are stored on the secondary server in case of failure of the first.

Preferably, the set comprises a first access-preservation table to receive reference data recorded from the insert transaction on each system table, a second access-preservation table to receive reference data recorded from the update transaction on each system table, and a third access preservation table to receive reference data recorded from the delete transaction on each system table. Preferably, the method comprises input restriction until the primary and secondary system databases are re-synchronised.

Preferably, the method comprises the contingency of applying the changes through at least a single database procedure using the combination transaction table and access-preservation tables, in order to resynchronise the primary and secondary systems once the database link is restored. Preferably, the method, comprises using Documentum as the Document Management System for both the primary and secondary system. Preferably the method comprises of using the primary system for the user community to store their documents. Preferably, the method comprises of using the secondary system as a disaster recovery system. Preferably, the method comprises document data being added to the filestore and reference data modified within Documentum system tables in the primary Oracle system database, and wherein the recording step comprises the step of recording reference data from all primary system tables, save those holding server specific data.

Preferably, the secondary system can be also used as a disaster recovery system in case of failure of the primary system. Preferably, in the case of disaster the secondary system can be used, the system is synchronised by applying the latest incremental filestore backup from the primary filestore and applying it to the secondary and accessing the transaction table and access-preservation tables to either back out or insert transactions up to the point of the backup that haven't already been automatically transferred.

Preferably, the system comprises a Documentum document management system, and wherein the method is carried out additionally it is appreciated that the secondary server be used as a “Standby” this is comprehended by this invention but is not the primary purpose. Preferably, the recording, inserting, updating, deleting and providing steps and standard database constructs are executed by the execution of Oracle database software code. Preferably, the recording, inserting, updating, deleting and providing steps and standard database constructs are executed by the execution of SQL Server database software code.

An example of the invention will now be described in detail with reference to the accompanying drawing in which;

### DRAWINGS

FIG. 1 is a schematic diagram of a preserved system in of disaster according to a first embodiment of the invention.

### DESCRIPTION OF THE INVENTION

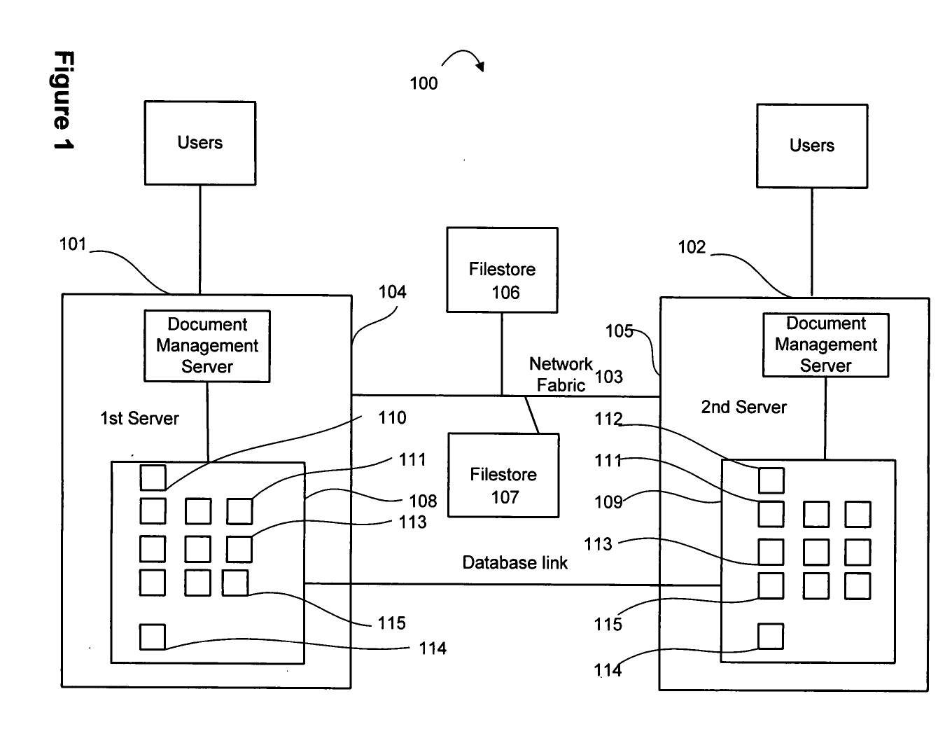

FIG. 1 shows a preserved system in case of disaster 100 according to a first embodiment of the invention that shows a secondary system in a offsite location and a primary system which allows the capture of relevant reference and supplementary document information at the exact time it is inserted, deleted or updated this by means of Oracle database triggers placed on each table except those needed to identify the primary and secondary as the primary and secondary on the network fabric and access-preservation tables, a single transaction table and incremental filestore backups. These triggers are added to the relevant Documentum tables and they automatically fire to capture and transfer the salient information. Incremental filestore backups are restored to the secondary system filestore.

According to one aspect of the Invention in the case of disaster the secondary system 102 can be used, the system is synchronised by applying the latest incremental backup and accessing the transaction table and access-preservation tables to either back out or insert transactions up to the time point of the incremental backup applied.

The primary system 101 is operably connected to a network fabric 103. The secondary system 102 is operably connected to the network fabric 103. The primary system has information loaded onto it, and is based on a first server 104. Preferably, the secondary system has information loaded onto it, and is based on a second server 105.

Preferably, the first system 101 and the second system 102 is configured to allow client computers operably connected to the network fabric 103 to locate information owned by the first system 101 and information owned by the second system 102. The second system 102 replicates the first system 101. Preferably, the second system 102 is located in an off-site location. Preferably, the first and second system 102 comprises a Document Management System residing on a servers 104,105 (Unix or Windows 2000 server) comprising of filestores 106, 107 storing the actual document data and system databases 108,109 storing reference information pointing to the documents within a filestores 106,107, supplementary information on the document, together with system specific information.

The second system's system database is configured to mirror the information in that of the first system's 101 system database 108 less a portion of the data which allows the second system 102 to be uniquely identified on the network fabric 103.

Preferably, the filestores 106,107 containing documents are connected to the network fabric 103. Preferably, the filestores 106,107 are based on a Storage Area Network (SAN) or Filer connected to the network fabric 103. Preferably, the primary system's 101 server can be connected to the filestore 106.

Preferably, the secondary system's server can be connected to a separate filestore the second filestore 107 in this case would need to have incremental backups from the first filestore to be continuously applied to it throughout perhaps at hourly intervals. Preferably, the incremental backup is done every hour and automatically applied to the secondary filestore 107. The primary and secondary system databases 108,109 are linked through the network fabric 103.

Preferably, the method comprises of using Oracle Database software linking primary and secondary system databases 108,109 on the network fabric 103 by means of an Oracle database link command. Preferably, in the case of a SQL Server database this link between primary and secondary system databases 108,109 is by a means of a SQL server linked server command. Preferably, both the primary and secondary systems databases 108,109 have the required access permissions to access, modify, insert or delete data in each other and are accessible to each other across the network fabric 103.

Preferably, the method comprises document data being added to the filestore 106 and reference data modified within system tables 110 in the primary system database 108, and wherein the recording step comprises the step of recording reference data from all primary system tables 110, save those holding system specific data. Preferably, the primary system 101, in response to an insert, an update, or an delete command, inserts, updates,deletes reference data to each of the system tables affected for each particular transaction. The recording step comprises recording the reference data using at least one database trigger 111.

Preferably, the recording step comprises recording the reference data using three database triggers 111 associated with each system table 110, excepting those tables, which allow the first system 101 to be uniquely identified on the network fabric 103.

Preferably, the method comprises adding a first database trigger associated with recording the changes after an insert command on each table, adding a second database trigger associated with recording the changes after an update command on each table and adding a third database trigger associated with recording the changes after a delete command on each database table 110, excepting those tables that define the primary system on the network fabric 103.

The method comprises performing identical changes, to that which can occur after an insert, update, delete command on each primary system database table 110 and are recorded within the respective database trigger 111 pertaining to that particular transaction to the identical replicated secondary system database table 112, by means of the salient SQL command contained within the three triggers on each of the primary database tables, the transfer, and application of the identical SQL command made possible only by the primary and secondary database systems 108, 109 being linked through a database link on the network fabric 103.

Preferably, the three triggers on each table in the primary database 108 also record the changes on update, insert, delete to access-preservation tables 113 and a single transaction table 114 for all changes on all tables. Preferably, the single transaction table 114 contains the group: the type of transaction (i.e. update, delete, Insert), the system table on which the transaction is performed, the primary key of the table, and a Date-timestamp. The recording step comprises using at least one access-preservation table 113. Preferably, the recording step comprises using a set of three access preservation tables for each primary system table 110 to be mirrored in the secondary's database tables 112. The method additionally comprises using a database stored procedure 115 to apply the changes and transactions recorded in the access-preservation tables and transaction table, to the secondary system should the database link be severed for any reason including that of maintenance to the secondary system on a time based input parameter, once the database link is restored and user input is halted temporarily. Preferably, a set of database procedures 115 can be used in contingency the database link is severed for any reason to apply the changes and transactions recorded and in order, from the time the link was severed to the secondary system in order to synchronise the two systems once the database link is restored again, user input to be halted at this point until the procedures have finished running, then the system can be returned to the said automated transfer using the SQL command within the triggers on each table, with the user input recommenced. Preferably, the access-preservation tables 113 and the combined transaction table 114 are stored on the secondary server in case of failure of the first. Preferably, the set comprises a first access-preservation table to receive reference data recorded from the insert transaction on each system table, a second access-preservation table to receive reference data recorded from the update transaction on each system table, and a third access preservation table to receive reference data recorded from the delete transaction on each system table. Preferably, the method comprises input restriction until the primary and secondary system databases are re-synchronised. Preferably, the method comprises the contingency of applying the changes through at least a single database procedure using the combination transaction table and access-preservation tables, in order to resynchronise the primary and secondary systems once the database link is restored. Preferably, the method, comprises using Documentum as the Document Management System for both the primary and secondary system. Preferably the method comprises of using the primary system for the user community to store their documents. Preferably, the method comprises of using the secondary system as a disaster recovery system. Preferably, the method comprises document data being added to the filestore and reference data modified within Documentum system tables in the primary Oracle system database, and wherein the recording step comprises the step of recording reference data from all primary system tables, save those holding server specific data. Preferably, the secondary system can be also used as a disaster recovery system in case of failure of the primary system. Preferably, in the case of disaster the secondary system can be used, the system is synchronised by applying the latest incremental filestore backup from the primary filestore and applying it to the secondary and accessing the transaction table and access-preservation tables to either back out or insert transactions up to the point of the backup that haven't already been automatically transferred. Preferably, the system comprises a Documentum document management system, and wherein the method is carried out additionally it is appreciated that the secondary server be used as a “Standby” this is comprehended by this invention but is not the primary purpose. Preferably, the recording, inserting, updating, deleting and providing steps and standard database constructs are executed by the execution of Oracle database software code. Preferably, the recording, inserting, updating, deleting and providing steps and standard database constructs are executed by the execution of SQL Server database software code.

The triggers are added to the relevant Documentum tables and they automatically fire to capture the salient information needed to apply a SQL command to keep two systems synchronised, where the secondary system is a replica of the first. This transfer is made possible by the setting up of a Database link between the primary and secondary database systems across the network fabric. In this case an Oracle Database link. Permissions to the user schema or database on the secondary system need to be granted to the primary system's schema or database, and visa versa in case of the secondary system taking over the role of the primary. Additionally, the database link could be set up using other databases of course using the relevant construct, as I have some experience with Sql Server I can at least provide the database mechanism to link two Sql server databases together namely the “linked server” construct. Though my experience is mainly within the Oracle database arena, most large database of any stature have to have similar constructs through common standards such as the SQL command language itself. So this method is very much multi-database.

Below, there is shown sample code which can be extended to implement the invention the code is by no means complete but is sufficient to demonstrate the method. Code is given for Oracle only. One system table is taken dm_sysobject_r as example from the Documentum system though not all the columns are used for the example to merely show the concept of the three trigger a table system that is embodied by this invention. The concept is however explained.

The Invention can be embodied in a multi-operating system embodiment. The invention can be embodied in a multi-document management system embodiment. The invention can be implemented in a multi-database embodiment.

Oracle

Create Database link link_name

Connect to username Identified by password

Using sqlnet_string;

e.g.

Create Database link Secondary

connect to secondary identified by secondary

using ‘backup_database’

It is appreciated that in the case of an Oracle delete trigger (a before or after) trigger can be used, as is comprehended by the invention.

Create or replace trigger keep_del_r_trigger
before delete on dm_sysobject_r
for each row
Begin
delete from dm_sysobject_r@backup_database where r_object_id =
:old.r_object_id
Insert into keep_r_table value@backup_database
(:old.r_object_id,:old.r_version_label,:old.i_folder_id,:SYSDATE);
Insert into transaction_table@backup_database
(‘Delete’,‘dm_sysobject_r’,:old.r_object_id,SYSDATE);
EXCEPTION
when others then
RAISE;
END;
/

The first command of the above trigger shows the SQL command and the “after delete row” trigger on the primary database automatically deletes the row in the secondary table. The insert statement is necessary in case the link is severed which can happen from time to time in case of maintenance, or in case of failure. As the above Oracle code shows this can be used in order to preserve the data in access preservation tables and the transaction table. In this case instead of using the link to transfer the necessary commands; the access-preservation tables and transaction table are used instead at a later point by database procedures that can run in the transactions in sequence to the Secondary Database. The triggers and procedures being “Enabled” in the secondary.

Create or replace trigger keep_ins_r_trigger
after insert on dm_sysobject_r
for each row
Begin
insert into
dm_sysobject_r@backup_database
(:new.r_object_id,:new.r_version_label,:new.i_folder_id)
Insert into keep_r_table value@backup_database
(:new.r_object_id,:new.r_version_label,:new.i_folder_id:,SYSDATE);
Insert into transaction_table@backup_database
(‘Insert’,‘dm_sysobject_r’,:new.r_object_id,SYSDATE);
EXCEPTION
when others then
RAISE;
END;
/

Notice the new values are used meaning the values after the insert or update of a row and these are subsequently used to apply changes to the secondary database.

Create or replace trigger keep_upd_r_trigger
after update on dm_sysobject_r
for each row
Begin
update dm_sysobject_r@backup_database set r_version_label =
:new.r_version_label,
i_folder_id = :new.i_folder_id where r_object_id = :new.r_object_id,
Insert into keep_r_table value@backup_database
(:new.r_object_id,:new.r_version_label,:new.i_folder_id:,SYSDATE);
Insert into transaction_table@backup_database
(‘Update’,‘dm_sysobject_r’,:old.r_object_id,SYSDATE);
EXCEPTION
when others then
RAISE;
END;
/

In the case of the dm_sysobject_r table above an example has been given of how the three triggers record the transactions for that table. This of course can be extended to every table within the system. A “before row delete” is used in the example, meaning the data the is about to be deleted is captured the :old values meaning whatever was there previously is always captured.

A “after row insert” and “after row update” is preferably used, meaning that the data values of the row that have been, inserted or updated are actually captured notice the new values inserted are always used. On a “before insert” old values do not exist. This ensures that all salient and/or relevant information is captured.

It will be appreciated that an “after row delete” and “before row update/insert” could also be used and are comprehended by the invention. In such a case, the old values are captured immediately upon the deletion and the new values upon update and insert.

An oracle database procedure or stored procedure is a piece of oracle execution code and carries out logical instructions. An oracle trigger is a piece of application code that can be applied to an oracle “table” (a storage unit like a filling cabinet) which when particular transactions are carried out on the table it fires automatically to execute the code within it.

1. A method for preserving access to document data entered by the user community within a primary system located on a primary server to a separate location, wherein said document data is stored in a system filestore associated with a system database, the system database containing reference data to point to the document data within the system filestore, by use of a replicated server containing a secondary system as a disaster recovery system the method comprising steps of:
(a) creating said replicated server containing the secondary system in which the reference data is configured to point to document data in a secondary system filestore the document data periodically being updated by copying data from the primary filestore and containing system database tables that mirror the primary system database tables save those tables containing reference data that uniquely identify the secondary sytem from the primary on a network;
(b) determining that an insert, an update, or an delete command has been issued within the primary production system database upon its system tables excepting those containing reference information that uniquely identifies the primary system from the secondary system on the network fabric;
(c) transferring and recording the said issued commands upon the primary system database tables to the database system tables of the secondary system based on time of earliest recorded data;
(d) in the event of failure of the primary system or of the network between the primary and replica server, changing the secondary system's database and or the secondary filestore so that the secondary system database corresponds with either the secondary or primary filestore.

2. The method according to claim 1 further comprising: connecting the primary and secondary system filestores;
basing the filestores on storage systems upon the network;
and periodically recording and copying changes to the primary system filestore to the secondary systems' filestore.

3. The method according to claim 1 further comprising:
using database software to link primary and secondary system databases on the network by means of a database link command;
using a network layer on the network; and
giving the primary database and secondary database the required access to transfer and record necessary changes to the tables.

4. The method according to claim 1 further comprising: recording the changes in reference data from all primary database system tables, apart from all primary database system tables holding specific data with regards to its definition as the primary system on the network, using at least one database trigger.

5. The method according to claim 1 or claim 4 further comprising:
adding a first database trigger associated with recording the changes after an insert command on each table excepting those tables that define the primary system on the network;
adding a second database trigger associated with recording the changes after an update command on each table excepting those tables that define the primary system on the network;
adding a third database trigger associated with recording the changes after an delete command on each table excepting those tables that define the primary system on the network.

6. The method according to any one of the claims 1 to 5 further comprising: the step of making a corresponding change to the secondary system database in response to a change to the primary system database by the user community.

7. The method according to claim 1, further comprising: the primary system database being arranged to have access preservation tables and or a transaction table, to preserve a record of all the changes; and
the corresponding changes being made to access preservation tables and or a transaction table added and located in the secondary system database.

8. The method according to any of claims 1 to 7, wherein in use, following breakage and subsequent restoration of the network link between the primary system and the secondary system, the step of changing the secondary system database and the secondary filestore further comprising:
copying data from the primary filestore to the secondary filestore; and
using procedure(s) added and stored in the secondary system database to retrieve any changes made to each of the system table(s), access preservation table(s) and transaction table since the time of breakage of the link from the primary system database.

9. The method according to any one of the claims 1 to 8, in which the primary and secondary systems are document management systems.

10. The method according to claim 1 wherein a corresponding change is made to the secondary system database in the event of failure of the primary system the system is controlled to change the replica system database so that the secondary system database corresponds with the secondary filestore.

11. The method according to claim 1 wherein in the event of failure of the primary system, and in the event the primary system filestore survives, the primary system filestore is connected to, or copied to the secondary system filestore the secondary system database which is rolled back to controlled to change create an operational document management system.

12. A document management recovery system, the document management recovery system comprising:
a replica system having a replica filestore and a replica system database for connection to a primary system having a primary filestore and a primary system database;
the system being arranged to periodically copy data from the primary filestore to the replica filestore and being arranged such that in response to a change to the primary system database, a corresponding change is made to the replica system database whereby in the event of failure of the primary system the system is controlled to change the replica system database to the replica filestore so that the replica system database corresponds with the replica filestore.

13. A document management recovery system, the document management recovery system comprising:
a replica system having a replica filestore and a replica system database for connection to a primary system having a primary filestore and a primary system database;
the system being arranged to periodically copy data from the primary filestore to the replica filestore and being arranged such that in response to a change to the primary system database, a corresponding change is made to the replica system database;
in the event of failure of the primary system, and in the event the primary system filestore survives, the primary system filestore is connected to,or copied to the replica system filestore, the replica system database is rolled back to create an operational document management system.

14. A document management system containing the document management recovery system as claimed in any of the claims 12 to 13.

15. An apparatus for a document management recovery system, comprising: a primary system based on a first server; and
a secondary system based on a second server, wherein the primary and secondary system are operable to be connected to a network fabric.

16. The apparatus according to claim 15, wherein salient user information is loaded onto the primary system and information is loaded onto the secondary system.

17. The apparatus according to claim 15 or claim 16, wherein the same information is loaded onto the primary and secondary system such that the secondary system is operable to replicate the primary system.

18. The apparatus according to any one of claims 15 to 17, further comprising information location means operable to allow at least one client computer connected to the said network fabric to locate first information owned by the primary system and second information owned by the secondary system.

19. The apparatus according to any one of claims 15 to 18, wherein at least one of the first server and the second server comprises a document management system.

20. The apparatus according to claim 19, wherein the document management system comprises at least one filestore operable to store document data.

21. The apparatus according to claim 19 or claim 20, wherein the document management system comprises a system database operable to store reference information pointing to the document data within the filestore.

22. The apparatus according to any one of claims 19 to 21, wherein the document management system comprises supplementary information about the document data and system specific information.

23. The apparatus according to any one of claims 15 to 22 wherein the primary system comprises a primary database and the secondary system comprises a secondary database.

24. The apparatus according to claim 23, wherein the primary database and the secondary database comprise database tables.

25. The apparatus according to claim 23 or claim 24, wherein the primary database and the secondary database are linked using a database network communication layer.

26. The apparatus according to any one of claims 23 to 25, wherein the primary database and the secondary database are operable to transfer and record changes to the database tables.

27. A computer readable medium embodying database software for recording and transferring steps as claimed in claim 26.
